(19) United States
(12) Patent Application Publication
(10) Pub. No.: US 2007/0038936 A1
(43) Pub. Date: Feb. 15, 2007

(54) Video directory for places, locations and/or services and a user interface for searching the said directory and displaying the result(s)

(76) Inventors: Brian Soroush Elmi, San Diego, CA (US); Faraz Yaghouti, San Diego, CA (US)

Correspondence Address: Brian S. Elmi, 8826 Via Andar, San Diego, CA, 92122, US

(21) Appl. No.: 11/203,476

(22) Filed: Aug. 12, 2005

(51) Int. Cl. H04N 5/44; G06F 17/30

(52) U.S. Cl. 715/721; 707/3

(57) ABSTRACT

A TCP/IP based application readable by a computer including but not limited to the Internet infrastructure and/or the World Wide Web which contains a database of plurality of video files in various formats that depict and describe a specific place, location and/or service, and implements the procedure of searching and displaying for the said files with a user interface consisting of: three window frames, displaying in the first window a search box for retrieving the indexed plurality of video files, in the second window the result of the search, and the third window the complete information for the selected record.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

1. Field of Invention

The present invention relates to yellow page directories, and more particularly a directory based on the World Wide Web infrastructure for personal computer or similar user device.

2. Description of the Related Art

Online directories are well known. They usually provide the computer user with a graphical user interface for searching a database, which contains text-based information such as phone number, address and category relating to various types of business establishments. Very limited number of the said directories may also contain an image representing various types of business establishments.

### BRIEF SUMMARY OF THE INVENTION

According to the present invention, a TCP/IP based application readable by a computer including but not limited to the Internet infrastructure and/or the World Wide Web which contains a database of plurality of video files in various formats that depict and describe a specific place, location and/or service and implements the procedure of searching and displaying for the said files with a user interface consisting of: three window frames and a plurality of panes within said window frames, displaying in the first window of the said window frames a search box for retrieving the indexed plurality of video files, in the second window of the said window frames the result of the search, and the third window of the said window frames the complete detail information for selected record.

In one embodiment of the present invention, there exists a database of plurality of video files in various formats which depict and describe a specific place, location and/or service and the video files consist of a plurality of shots depicting and describing the said place, location and/or service, beginning and ending with the sign and/or logo of each said place, location and/or service. In another embodiment, a window contains a user accessible search box. As the user performs a search, the second window of the said window frames displays those records of the plurality of video files that best match the search keyword(s) or the criteria selected by the user from the pre-populated drop downs. In still another embodiment, the records displayed in the second window of the said window frames are listed alongside a thumbnail representing a frame in the video that depicts the sign and/or logo of each specific place, location and/or service. In yet another embodiment, the third window of the said window frames contains a player for playback and control of the video file selected in the second window of the said window frames. In still another embodiment, in the third window of the said window frames a user selectable button allows the user to receive coupons and/or savings electronically via cell phones, PDAs and any other devices alike.

These and other objects, advantages and features of the present invention will become readily apparent to those skilled in the art from a study of the following Description of the Exemplary Preferred Embodiments when read in conjunction with the attached Drawing and appended claims.

### BRIEF DESCRIPTION OF THE SEVERAL VIEWS OF THE DRAWING

FIGS. 1-3 are representative of the graphic user interface used for searching the database of plurality of video files which depict and describe a certain place, location and/or service in accordance with the present invention;

FIG. 4 is a representation of retrieval process of the video files on a server using a database application; and

FIG. 5 is a representation of one method of accessing the Video Directory.

### DESCRIPTION OF THE EXEMPLARY PREFERRED EMBODIMENTS

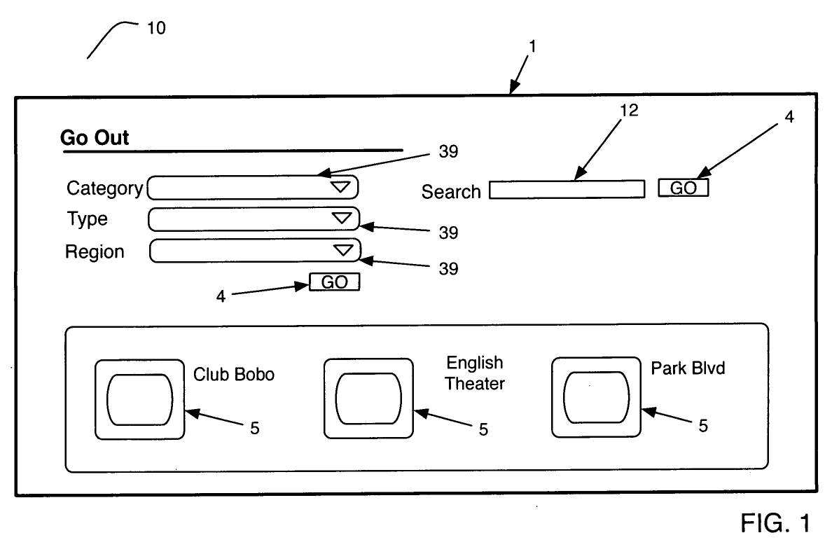

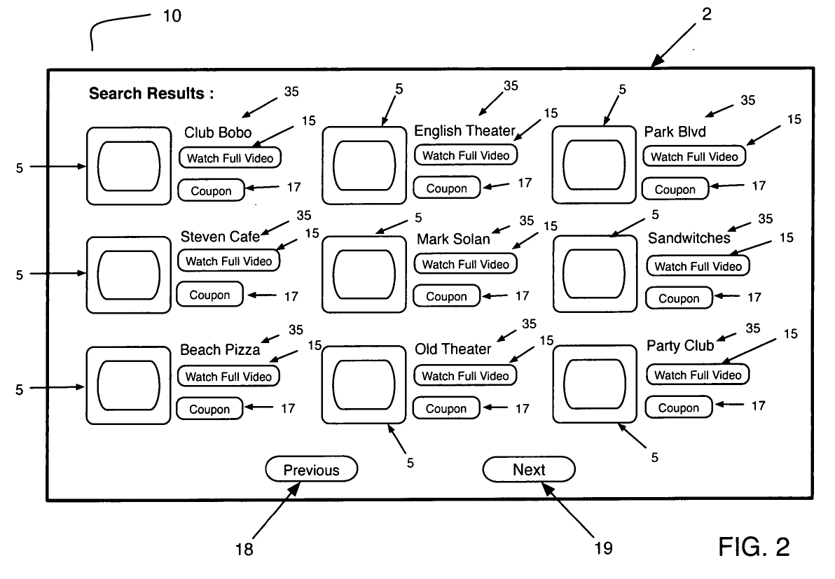

As best seen in FIG. 1, in accordance with another exemplary embodiment of the present invention, there is a search box 12 displayed in the first window 1 of the said window frames 10, where the user can input the search keyword and perform the search by selecting the Go button 4 which will initiate the search process of the database of plurality of video files based on the keyword(s) input by the user. As also seen in FIG. 1, the user can perform a search by selecting criteria from pre-populated drop downs 39 and perform the search by selecting the Go button 4 which will initiate the search process of the database of plurality of video files based on the selected criteria in the pre-populated drop downs 39. Now referring to FIG. 2, the second window 2 of the said window frames 10 displays those records of the plurality of video files that best match the search keyword(s) or the criteria selected by the user from the pre-populated drop downs 39. In another exemplary embodiment of the present invention, the records displayed in the second window 2 of the said window frames 10 are listed alongside a thumbnail 5 representing a frame in the video that depicts the sign and/or logo of each specific place, location and/or service. The second window 2 of the said window frames 10 may include alongside of each search result: a Watch full Video button 15 to allow the user through the user interface to watch the video, and a Coupons button 17 to transmit savings and/or coupons electronically to the users cell phone, PDA and other devices alike. The second window 2 of the said window frames 10 may further include a Previous 18 and Next 19 buttons for allowing the user to go back and forth through the records displayed as the result of the search performed.

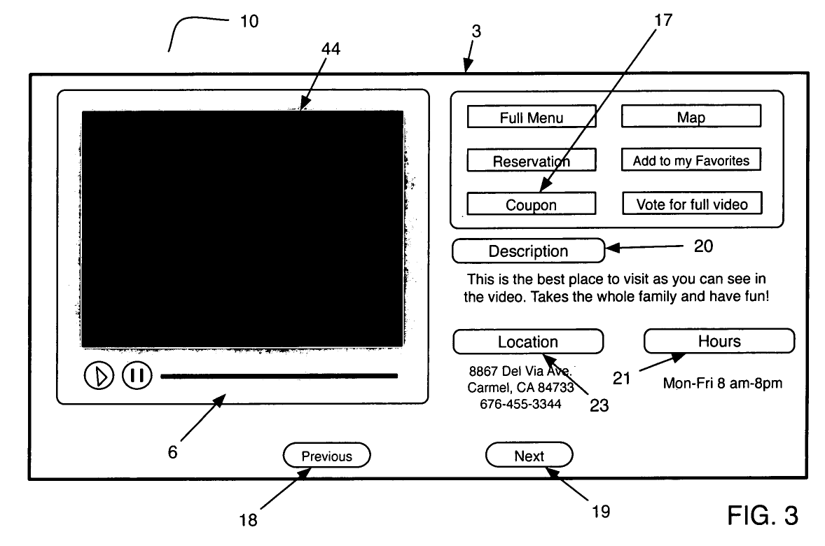

In accordance with yet another exemplary embodiment of the present invention, as best seen in FIG. 3, the third window 3 of the window frames 10 includes a video player and controller 6 for the playback of the video file 44 of the selected place, location and/or service in the second window 2 of the window frames 10. In another accordance with the exemplary embodiment of the present invention, the third window 3 of the window frames 10 will include a Coupon button 17 for electronically transmitting coupons and/or savings to the users cell phone, PDA, and other devices alike. In yet another embodiment of the present invention, a user selectable Previous button 18 and Next button 19, will allow the user to go back and forth through the detailed information of the records displayed in the second window 2 of the window frames 10. The third window 3 of the window frames 10 may also include user selectable buttons such as: Description button 20 which upon selection will reveal the description of the place, location and/or service depicted in the video, Location button 23 which upon selection will reveal the address and location information of the place, location and/or service, an Hours button 21 which upon selection will reveal the hours of operation for the specific place, location and/or service. The Description button 20, Location button 23 and Hours button 21 will be treated as selected when a user initially displays the third window 3 of the said window frames 10.

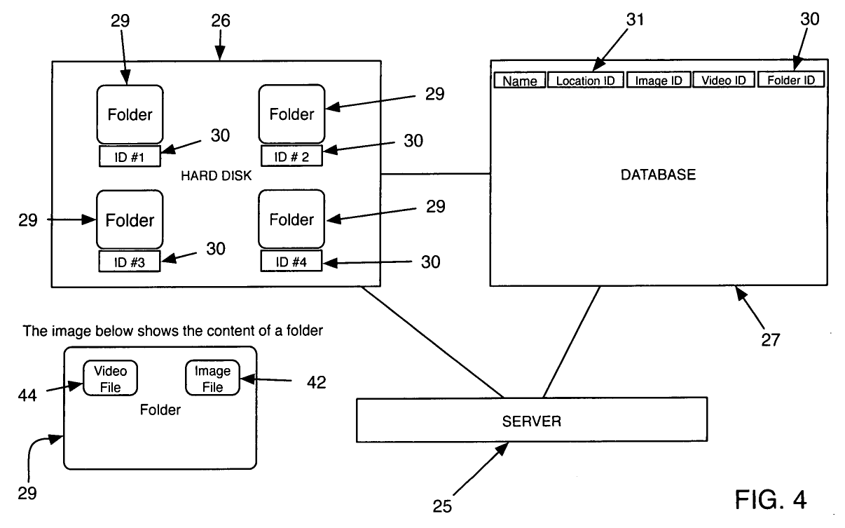

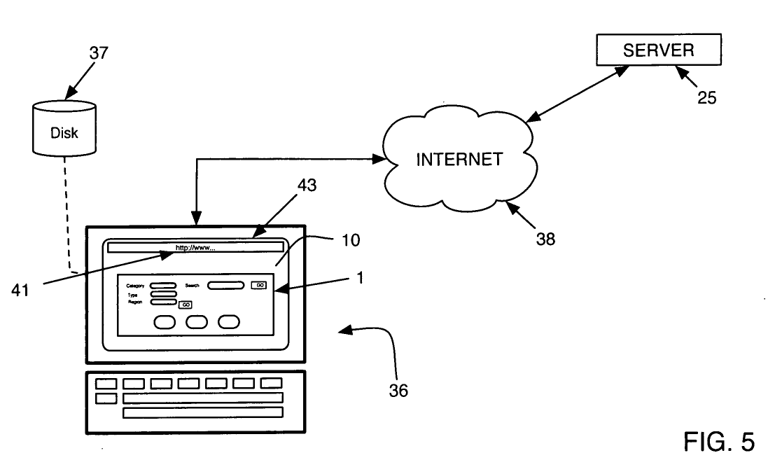

Referring now to FIG. 5, in a preferred embodiment of the present invention, the first window 1 of the said window frames 10 as best seen in FIG. 1 may be generated in an application such as a web browser 43 of a computer 36 as seen in FIG. 5. The computer 36 contains a computer readable medium, such as a disk 37, which contain as application code, such as a web browser. The code, when executed would allow the user to type in the direct web address 41 and communicate with the server 25, which contains the video files 44 and the database application 27 as seen in FIG. 4, through the Internet 38 and generate the first window 1 of the said window frames 10 and implement the following described procedures.

As seen in FIG. 4, in accordance with one exemplary embodiment of the present invention, there exists a database application 27 of plurality of unique folders 29 where each one contains a video file 44 which depicts a certain place, location and/or service. There exists a server 25, which contains a rewritable medium such as a hard disk 26, which unique folders 29 with assigned unique folder IDs 30 for each place, location and/or service are placed on. The database application 27 is run on the server and communicates with the first window 1, second window 2 and third window 3 of the said window frames 10. When a user performs a search in the first window 1 of the said window frames 10, as seen in FIG. 1, a search query is sent to the database application 27 on the server 25. The database application 27 then identifies the query with certain location ID 31 which has a certain folder ID 30. Then database reads the image file 42 inside the folder 29 with the identified folder ID 30 in the database application 27, and displays the appropriate file on the second window 2 of the said window frames 10 as shown in FIG. 2. When a user in the second window 2 of the said window frames 10 selects a record 35, the database application 27 displays all the relative information to that specific place, location and/or service as best seen in FIG. 3 along with the video file 44 which is located in a specific folder 29 with a unique folder ID 30, for that specific record 35 on the third window 3 of the said window frames 10.

1. A TCP/IP based application readable by a computer including but not limited to the Internet infrastructure and/or the World Wide Web which contains:
a database of plurality of video files in various formats that depict a specific place, location and/or service;
method of searching for the said files;
a user interface consisting of three window frames;
displaying in the first window of the said window frames a search box for retrieving the indexed plurality of video files;
displaying in the second window of the said window frames the retrieved records filtered by the users input in the said first window; and
displaying in the third window of the said window frames the detailed information for the selected record in the second said window;
wherein the second window is initiated and displayed with a users input to search the indexed database of plurality of video files in the said first window and, the third window is initiated and displayed with a user record selection from the plurality of records displayed in the second said window.

2. A TCP/IP based application readable by a computer as set forth in claim 1 wherein each video file is associated with a place, location and/or service, which is identified by a specific number within the database of plurality of video files.

3. A TCP/IP based application readable by a computer as set forth in claim 2 wherein said video files consist of a plurality of shots depicting and/or describing the said place, location and/or service beginning and ending with the sign and/or logo of each said place, location and/or service.

4. A TCP/IP based application readable by a computer as set forth in claim 1 comprising of displaying a search field in the first window of the said window frames wherein the user can input keyword(s) for searching the plurality of video files which initiates and displays the second window of the said window frames.

5. A TCP/IP based application readable by a computer as set forth in claim 1 further comprising of displaying pre-populated drop downs, which contain specific criteria for searching the plurality of video files.

6. A TCP/IP based application readable by a computer as set forth in claim 4 wherein the retrieved records from the database of the plurality of video files are displayed in the second window of the said window frames.

7. A TCP/IP based application readable by a computer as set forth in claim 5 wherein the said records are listed along side a thumbnail representing a frame in the video that depicts the sign and/or logo of each specific place, location and/or service.

8. A TCP/IP based application readable by a computer as set forth in claim 5 wherein selecting one of said records in the second window of the said window frames will initiate and display the third window of the said window frames.

9. A TCP/IP based application readable by a computer as set forth in claim 7 wherein the third window of the said window frames contains detailed information alongside the video which depicts and describes the selected record in the second window of the said window frames.

10. A TCP/IP based application readable by a computer as set forth in claim 8 wherein the third window of the said window frames further comprises of a video player for controlling the play back of the said video files.

11. A TCP/IP based application readable by a computer as set forth in claim 8 wherein the third window of the said window frames further comprises a button for electronically transmitting savings and/or coupons to the user upon users selection of the button.
